(19) United States
(12) Patent Application Publication
(10) Pub. No.: US 2018/0063173 A1
(43) Pub. Date: Mar. 1, 2018

(54) APPARATUS FOR INFORMATION PROCESSING, SYSTEM FOR INFORMATION PROCESSING, AND METHOD FOR INFORMATION PROCESSING

(71) Applicant: FUJITSU LIMITED, Kawasaki-shi (JP)

(72) Inventors: Tomoharu Imai, Kawasaki (JP); Kazuki Matsui, Kawasaki (JP)

(73) Assignee: FUJITSU LIMITED, Kawasaki-shi (JP)

(21) Appl. No.: 15/657,429

(22) Filed: Jul. 24, 2017

(30) Foreign Application Priority Data
Aug. 31, 2016 (JP) 2016-170004

(51) Int. Cl. H04L 29/06; H04L 29/08

(52) U.S. Cl. CPC H04L 63/1416; G06F 3/14; H04L 67/2814

(57) ABSTRACT

An information processing apparatus includes a memory configured to store identifying information of a web page conforming to a predetermined condition and a processor coupled to the memory. The processor is configured to perform receiving identifying information from a server to provide a terminal with an image converted from a web page or the identifying information of the web page, determining whether the web page identified by the identifying information satisfies the predetermined condition, first transmitting the received identifying information to the server when the determining determines that the web page identified by the identifying information satisfies the predetermined condition, acquiring the web page identified by the identifying information when the determining determines that the web page identified by the identifying information does not satisfy the predetermined condition, and second transmitting the acquired web page to the server.

### CROSS-REFERENCE TO RELATED APPLICATION

This application is based upon and claims the benefit of priority of the prior Japanese Patent Application No. 2016-170004, filed on Aug. 31, 2016, the entire contents of which are incorporated herein by reference.

### FIELD

The embodiments discussed herein are related to an information processing apparatus, an information processing system, and an information processing method.

### BACKGROUND

A thin client system is utilized for taking a security measure and reducing a management cost. In the thin client system, a screen outputted by a thin client server is transferred to a thin client terminal used by a user.

### DOCUMENTS OF RELATED ARTS

### Patent Documents

### [Patent Document 1] Japanese Laid-open Patent Publication No. 2015-069544

### [Patent Document 2] Japanese Laid-open Patent Publication No. 2004-157577

### SUMMARY

According to an aspect of the embodiments, an information processing apparatus includes a memory and a processor. The memory is configured to store identifying information of a web page conforming to a predetermined condition. The processor is coupled to the memory. The processor is configured to perform receiving identifying information from a server to provide a terminal with an image converted from a web page or the identifying information of the web page, determining whether the web page identified by the identifying information satisfies the predetermined condition, based on the identifying information stored in the memory and the received identifying information, first transmitting the received identifying information to the server when the determining determines that the web page identified by the identifying information satisfies the predetermined condition, acquiring the web page identified by the identifying information when the determining determines that the web page identified by the identifying information does not satisfy the predetermined condition, and second transmitting the acquired web page to the server.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a diagram illustrating one example of an architecture of a thin client system according to an embodiment;

FIG. 2 is a diagram illustrating one example of a hardware configuration of an information processing apparatus;

FIG. 3 is a diagram illustrating one example of processing blocks of a proxy server;

FIG. 4 is a diagram illustrating one example of processing blocks of a thin client server;

FIG. 5 is a diagram illustrating one example of processing blocks of a thin client application running on a thin client terminal;

FIG. 6 is a first flowchart illustrating one example of a processing flow of the proxy server;

FIG. 7 is a second flowchart illustrating one example of the processing flow of the proxy server;

FIG. 8 is a third flowchart illustrating one example of the processing flow of the proxy server;

FIG. 9 is a fourth flowchart illustrating one example of the processing flow of the proxy server;

FIG. 10 is a fifth flowchart illustrating one example of the processing flow of the proxy server;

FIG. 11 is a flowchart illustrating one example of a processing flow of the thin client server;

FIG. 12 is a flowchart illustrating one example of processes of the thin client terminal;

FIG. 13 is a diagram illustrating one example of a process of a first scenario by the thin client system according to the embodiment;

FIG. 14 is a first diagram illustrating one example of a process of a second scenario by the thin client system according to the embodiment;

FIG. 15 is a second diagram illustrating one example of a process of the second scenario by the thin client system according to the embodiment;

FIG. 16 is a first diagram illustrating one example of a process of a third scenario by the thin client system according to the embodiment;

FIG. 17 is a second diagram illustrating one example of the process of the third scenario by the thin client system according to the embodiment; and

FIG. 18 is a diagram illustrating one example of a thin client system according to a comparative example.

### DESCRIPTION OF EMBODIMENTS

Some of web pages opened on the Internet have intrusion of malware with which accessing client terminals are infected. The malware is, e.g., software that causes the infected client terminal to perform an operation unintended to the user. For example, the client terminal is infected with the malware exploiting a variety of scripts running on the web pages. In the thin client system, the client server converts a screen of the web page into an image as part of countermeasures against the malware infection. The thin client server transfers the converted image to a thin client terminal. The thin client terminal causes a display unit instanced by a display to display the transferred image. The screen of the web page is converted into the image, thereby invalidating the variety of scripts running on the web page. The thin client terminal can be thereby restrained from being infected with the malware exploiting the variety of scripts running on the web page.

However, the conversion of the web page into the image makes it difficult to use the web page containing a dynamic content instanced by a moving picture. The conversion of the web page into the image consequently might cause a decline of convenience in terms of using the web page.

The thin client system according to one embodiment will hereinafter be described with reference to the drawings. A configuration of the following embodiment is an exemplification, and a technology of the disclosure is not limited to the configuration of the embodiment.

### Embodiment

The thin client system according to the embodiment determines whether a web page requested as an access destination is a secure web page. When determined not to be the secure web page, a web page screen is converted into an image, and the image is transferred to a thin client terminal. The thin client terminal displays the transferred image on a display. Whereas when determined to be the secure web page, information containing a Uniform Resource Locator (URL) of the web page is transmitted to the thin client terminal. The thin client terminal displays, based on the received URL, the web page on a web browser. The thin client system according to the embodiment will hereinafter be described with reference to the drawings.

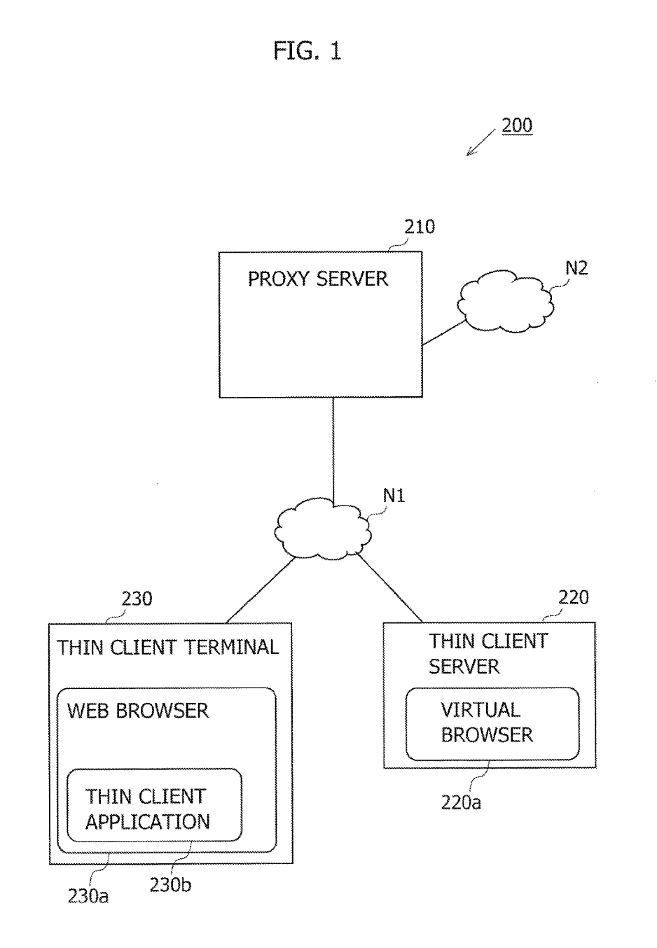

FIG. 1 is a diagram illustrating one example of an architecture of a thin client system 200 according to the embodiment. The thin client system 200 according to the embodiment includes a proxy server 210, a thin client server 220 and a thin client terminal 230. The proxy server 210, the thin client server 220 and the thin client terminal 230 are interconnected via a network N1. The proxy server 210 is connected also to a network N2 different from the network N1. The network N1 is, e.g., an intra-network built up in house. The network N1 may include a network connected to the intra-network by a Virtual Private Network (VPN). The network N2 is instanced by the Internet. The proxy server 210, the thin client server 220 and the thin client terminal 230 are information processing apparatuses. The information processing apparatuses are mutually communicable by Transmission Control Protocol/Internet Protocol (TCP/IP) on the network N1 and the network N2.

The proxy server 210 relays communications among the thin client server 220, the thin client terminal 230 and the network N2. The proxy server 210 accepts a request containing a URL of the web page from a virtual browser 220a within the thin client server 220 and from the thin client terminal 230. The proxy server 210 determines whether the web page specified by the URL contained in the request is a secure web page. The proxy server 210 transmits a thin client application 230b to the thin client terminal 230. The thin client application 230b is an application developed by, e.g., HyperText Markup Language (HTML) and JavaScript (registered trademark). The thin client application 230b may also be an application developed by, e.g., HTML5. In other words, the thin client application 230b may be developed by whatever programming language, as far as being runnable on a web browser 230a. The thin client application 230b runs on the web browser 230a of the thin client terminal 230. The proxy server 210 is one example of a “first server”. The URL is one example of “identifying information”. The web browser 230a is one example of a “second displaying”. The thin client application 230b is one example of a “first displaying”.

The virtual browser 220a within the thin client server 220 is operated via the thin client application 230b running on the thin client terminal 230. The request containing the URL of the web page is inputted to the thin client application 230b. Upon the input of the request, the thin client application 230b transmits the request to the virtual browser 220a of the thin client server 220. The virtual browser 220a transmits the received request to the proxy server 210 in order to display the web page having the URL contained in the request. The proxy server 210, when determining that the web page URL contained in the request is a secure URL, notifies the thin client server 220 of request information. The thin client server 220 converts the received request information into a web page display command, and transmits this web page display command to the thin client application 230b. The web page display command contains the URL of the web page determined to be secure. Whereas when the web page URL contained in the request is determined not to be secure, the proxy server 210 acquires the web page, and transmits data of the acquired web page to the virtual browser 220a. The virtual browser 220a within the thin client server 220 outputs the received web page data to the screen. The virtual browser 220a converts the web page data outputted to the screen into the image. The thin client server 220 transmits the converted image to the thin client terminal 230. The thin client server 220 is one example of a “second server”.

The thin client terminal 230 is a terminal used by a user. The thin client terminal 230 includes the web browser 230a. The web browser 230a is enabled to display the web page developed in languages including the HTML and JavaScript. The web browser 230a is enabled to run applications compiled in HTML and JavaScript. The web browser 230a is also enabled to run applications compiled in HTML5. The thin client application 230b transmitted from the proxy server 210 is runnable on the web browser 230a. The thin client application 230b displays the image transmitted from the thin client server 220. The thin client application 230b detects an operation performed on the displayed image. The thin client application 230b transmits the detected operation to the thin client server 220. The thin client application 230b, upon receiving the web page display command described above, instructs the web browser 230a to display the web page specified by the URL contained in the web page display command. The thin client terminal 230 is one example of a “terminal”.

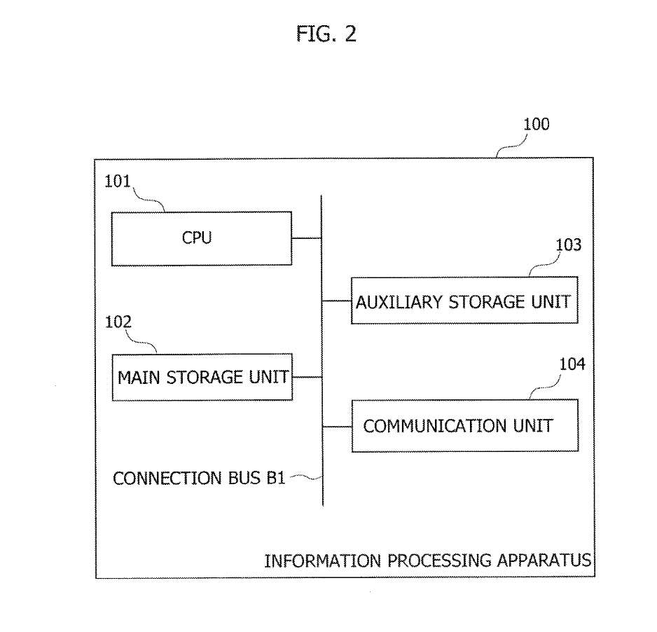

FIG. 2 is a diagram illustrating one example of a hardware configuration of an information processing apparatus 100. The information processing apparatus 100 includes a Central Processing Unit (CPU) 101, a main storage unit 102, an auxiliary storage unit 103, a communication unit 104, and a connection bus B1. The CPU 101, the main storage unit 102, the auxiliary storage unit 103 and the communication unit 104 are interconnected via the connection bus B1. The information processing apparatus 100 is usable as, e.g., the proxy server 210, the thin client server 220 and the thin client terminal 230.

In the information processing apparatus 100, the CPU 101 deploys a program stored in the auxiliary storage unit 103 onto a work area of the main storage unit 102, and controls peripheral devices by running the program. The information processing apparatus 100 is thereby enabled to execute processes matching with predetermined purposes. The main storage unit 102 and the auxiliary storage unit 103 are non-transitory recording mediums readable by the information processing apparatus 100.

The main storage unit 102 is exemplified as a storage unit that is accessed directly from the CPU 101. The main storage unit 102 includes a Random Access Memory (RAM) and a Read Only Memory (ROM).

The auxiliary storage unit 103 stores various categories of programs and various items of data on the recording medium in a readable/writable manner. The auxiliary storage unit 103 is also called an external storage device. The auxiliary storage unit 103 stores an Operating System (OS), the various categories of programs, various types of tables and other equivalent software components. The OS contains a communication interface program for receiving and transferring the data from and to external apparatuses connected via the communication unit 104. The external apparatuses include, e.g., other information processing apparatuses and external storage devices that are connected via, e.g., a computer network and other equivalent networks. Note that the auxiliary storage unit 103 may also be part of a cloud system defined as a cluster of computers on the network.

The auxiliary storage unit 103 is exemplified by an Erasable Programmable ROM (EPROM), a Solid State Drive (SSD), and a Hard Disk Drive (HDD). The auxiliary storage unit 103 is also exemplified by a Compact Disc (CD) drive, Digital Versatile Disc (DVD) drive, and a Blu-ray Disc (BD) drive. The auxiliary storage unit 103 may also be provided by a Network Attached Storage (NAS) or a Storage Area Network (SAN).

The recording medium readable by the information processing apparatus 100 connotes a non-transitory recording medium capable of accumulating information instanced by data, programs and other equivalent information electrically, magnetically, optically, mechanically or by chemical action, which can be read from the information processing apparatus 100. Among these non-transitory recording mediums, the mediums removable from the information processing apparatus 100 are exemplified by a flexible disc, a magneto-optic disc, a CD-ROM, a CD-R/W, a DVD, a Blu-ray disc, a DAT, an 8 mm tape, and a memory card like a flash memory. The hard disc, the SSD or the ROM and other equivalent recording mediums are given as the non-transitory recording mediums fixed within the information processing apparatus 100.

The communication unit 104 is, e.g., an interface with the computer network. The communication units 104 of the thin client server 220 and the thin client terminal 230 are the interfaces with the network N1. The proxy server 210 includes the two communication units 104, one of which is the interface with the network N1, and the other of which is the interface with the network N2.

The information processing apparatus 100 may further include, e.g., an input unit to accept an operation instruction and other equivalent indications from the user and other equivalent persons. This type of input unit can be exemplified by input devices, i.e., a keyboard, a pointing device, a touch panel, an acceleration sensor or a voice input device.

The information processing apparatus 100 may be configured to include a display unit to display data to be processed by, e.g., the CPU 101 and data to be stored in the main storage unit 102. This type of display unit can be exemplified by display devices, i.e., a Cathode Ray Tube (CRT) display, a Liquid Crystal Display (LCD), a Plasma Display Panel (PDP), an Electroluminescence (EL) panel or an organic EL panel.

<Processing Blocks>

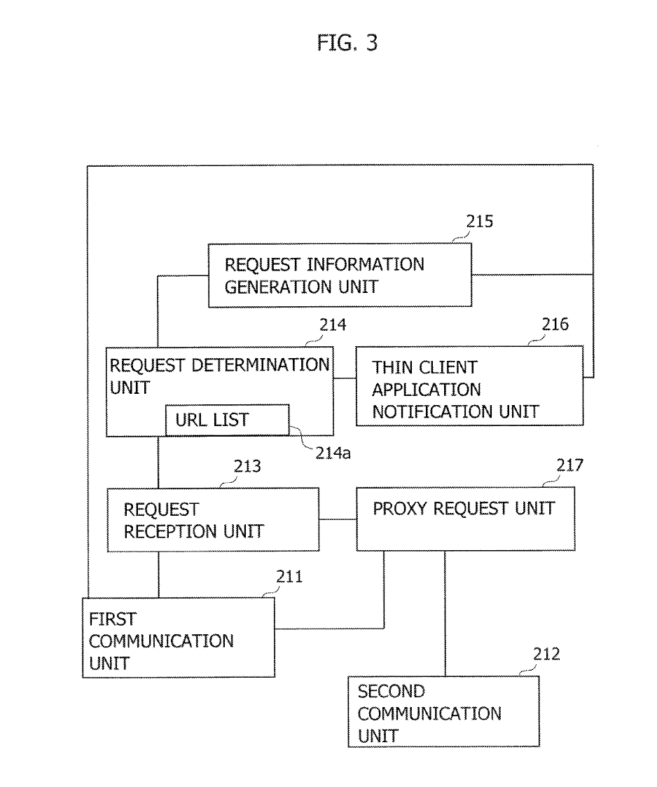

FIGS. 3, 4 and 5 are diagrams illustrating one examples of processing blocks of the proxy server 210, the thin client server 220 and the thin client terminal 230, respectively. Each of the proxy server 210, the thin client server 220 and the thin client terminal 230 includes, as depicted in FIG. 2, the CPU 101 and the main storage unit 102. The CPU 101 of each of the proxy server 210, the thin client server 220 and the thin client terminal 230 executes processes of the processing blocks illustrated in FIGS. 3, 4 and 5 in accordance with the computer program deployed in an executable manner on the main storage unit 102. The CPU 101 is also called a Microprocessor (MPU) or a processor. It does not mean that the CPU 101 is limited to a single processor, and the CPU 101 may take a multiprocessor configuration. The single CPU 101 connected by a single socket may also take a multicore configuration. At least part of processes of the processing blocks may be executed by a processor other than the CPU 101, e.g., a dedicated processor including a Digital Signal Processor (DSP), a Graphics Processing Unit (GPU), a numerical data processor, a vector processor and an image processing processor. At least part of the processes of the processing blocks in FIGS. 3-5 may also be of an integrated circuit (IC) and other digital circuits. At least part of the processing blocks may include an analog circuit. The integrated circuit includes an LSI, an Application Specific Integrated Circuit (ASIC), and a Programmable Logic Device (PLD). The PLD includes, e.g., a Field-Programmable Gate Array (FPGA). The processing block may also be configured as a combination of the processor and the integrated circuits. The combination is called, e.g., a microcontroller unit (MCU), a System-on-a-Chip (SoC), a system LSI or a chipset.

<Processing Blocks of Proxy Server 210>

FIG. 3 is a diagram illustrating one example of the processing blocks of the proxy server 210. FIG. 3 illustrates the respective processing blocks, i.e., a first communication unit 211, a second communication unit 212, a request reception unit 213, a request determination unit 214, a request information generation unit 215, a thin client application notification unit 216, and a proxy request unit 217.

The first communication unit 211 is an interface with the network N1. The second communication unit 212 is an interface with the network N2. The first communication unit 211 transmits and receives the data to and from the network N1 via the communication unit 104 in FIG. 2. The second communication unit 212 transmits and receives the data to and from the network N2 via the communication unit 104 in FIG. 2.

The request reception unit 213 receives the requests from the thin client server 220 and the thin client terminal 230 via the first communication unit 211. The request contains, e.g., the web page URL. The request reception unit 213 transmits the received request to the request determination unit 214. The request reception unit 213 is one example of “receiving” and “first receiving”.

The request determination unit 214 determines, e.g., whether the web page identified by the URL contained in the request is a secure web page. The request determination unit 214 retains, e.g., a URL list 214a containing listed URLs of the secure web pages. It may be sufficient that the URL list 214a is created, e.g., when making initial settings of the thin client system 200. The request determination unit 214 determines whether the URL list 214a contains a URL coincident with the URL contained in the request. When the URL list 214a contains the URL contained in the request, the request determination unit 214 determines that the web page specified by the URL is the secure web page. Whereas when the URL list 214a does not contain the URL contained in the request, the request determination unit 214 determines that the web page specified by the URL is not the secure web page. The request determination unit 214 is one example of “determining”. The URL list 214a is one example of a “memory configured to store identifying information of a web page conforming to a predetermined condition”. The URL of the secure web page is one example of “the identifying information of a web page conforming to a predetermined condition”.

The request information generation unit 215 transmits, to the thin client server 220, the URL of the web page determined to be the secure web page by the request determination unit 214. The request information generation unit 215 is one example of “first transmitting”.

The thin client application notification unit 216 transmits the thin client application 230b to the thin client terminal 230 when the request determination unit 214 determines that the web page specified by the URL contained in the request is not the secure web page.

The proxy request unit 217 extracts the URL contained in the request. The proxy request unit 217 accesses the web page identified by the extracted URL. The proxy request unit 217 acquires data containing the HTML of the web page from the accessed web page. In the present specification, “acquiring the data containing the HTML of the web page will hereinafter be referred to as “acquiring the web page”. The proxy request unit 217 transmits the acquired web page to the thin client server 220 via the first communication unit 211. The proxy request unit 217 is one example of “acquiring” and “second transmitting”.

<Processing Blocks of Thin Client Server 220>

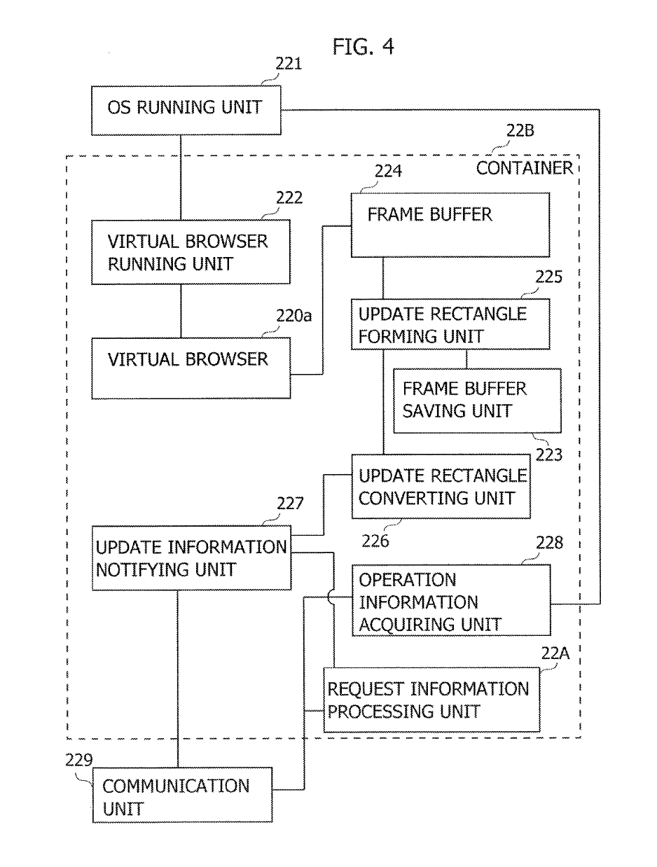

FIG. 4 is a diagram illustrating one example of processing blocks of the thin client server 220. FIG. 4 illustrates processing blocks, i.e., an OS running unit 221, a virtual browser running unit 222, a virtual browser 220a, a frame buffer saving unit 223, a frame buffer 224, an update rectangle forming unit 225, an update rectangle converting unit 226, an update information notifying unit 227, an operation information acquiring unit 228, a communication unit 229, a request information processing unit 22A, and a container 22B.

The OS running unit 221 provides an Application Programming Interface (API). The respective processing units illustrated in FIG. 4 are capable of transferring and receiving the information by using, e.g., the API provided by the OS running unit 221.

The operation information acquiring unit 228 acquires information of an operation manipulated on the thin client application 230b running on the thin client terminal 230. The operation information contains coordinate data indicating a position in which a mouse is clicked on the thin client application 230b. The operation information acquiring unit 228 transmits the acquired operation information to the virtual browser running unit 222 by using, e.g., the API provided by the OS running unit 221.

The virtual browser 220a converts the received web page into an image, and outputs the image to the frame buffer 224. The frame buffer 224 is a buffer to save the outputted latest image. The frame buffer 224 is built on, e.g., the main storage unit 102 of the thin client server 220.

The update rectangle forming unit 225 compares the image acquired from the frame buffer 224 and the image saved in the frame buffer saving unit 223. The frame buffer saving unit 223 is a buffer that saves the image acquired last time. The update rectangle forming unit 225 extracts a rectangular area covering an updated region from the image acquired last time, based on the comparison made above. The update rectangle forming unit 225 saves, in the frame buffer saving unit 223, the image in the frame buffer 224, which is acquired when compared after extracting the rectangular area. The frame buffer saving unit 223 is built on, e.g., the main storage unit 102 of the thin client server 220.

The update rectangle converting unit 226 compresses an image of the rectangular area extracted by the update rectangle forming unit 225 in a predetermined image compression format. As the predetermined image compression format, there can be adopted a variety of image compression formats instanced by Joint Photographic Experts Group (JPEG), Portable Network Graphics (PNG) and Graphics Interchange Format (GIF).

The update information notifying unit 227 transmits the image compressed by the update rectangle converting unit 226 to the thin client terminal 230 via the communication unit 229. The update information notifying unit 227 is one example of “first transmitting”.

The virtual browser running unit 222 runs the virtual browser 220a. The virtual browser running unit 222 is notified of the operation information acquired by the operation information acquiring unit 228 via the OS running unit 221. The notified operation information is handed over the virtual browser 220a and inputted to the web page displayed within the virtual browser 220a. For example, when notified of the operation information containing the click operation of the mouse, the click operation is performed at a currently existing position of a mouse cursor. When a link containing the URL exists in the position of the click operation being performed, there is conducted an operation of displaying the web page specified by the URL.

The communication unit 229 is an interface with the network N1. The communication unit 229 transmits and receives the data to and from the network N1 via the communication unit 104 in FIG. 2. The communication unit 229 is one example of “receiving”.

The request information processing unit 22A transmits, to the thin client application 230b, the web page display command containing the URL of the web page determined to be the secure web page by the proxy server 210. The request information processing unit 22A is one example of “second transmitting.

The container 22B contains the virtual browser running unit 222, the virtual browser 220a, the frame buffer saving unit 223, the frame buffer 224, the update rectangle forming unit 225, the update rectangle converting unit 226, the update information notifying unit 227, the operation information acquiring unit 228 and the request information processing unit 22A. The container 22B is prepared per thin client terminal 230 connected to the thin client server 220. Inhibited is an access from the container 22B prepared for a certain thin client terminal 230 to the container 22B prepared for another thin client terminal 230. As a result, even when some sort of fault occurs within the container 22B prepared for a certain thin client terminal 230, another container 22B can be restrained from being affected. The container 22B is also referred to as a sandbox.

<Processing Blocks of Thin Client Terminal 230>

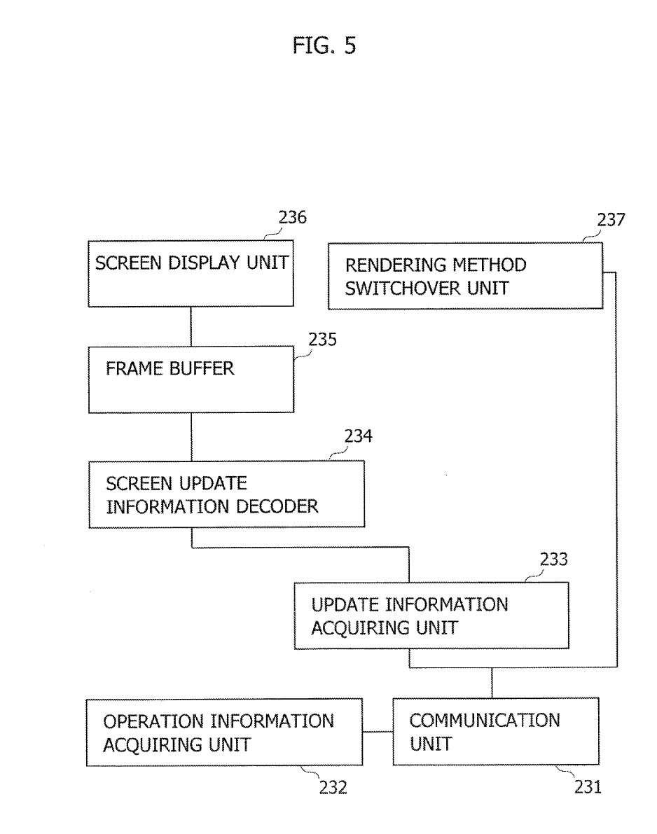

FIG. 5 is a diagram illustrating one example of processing blocks of the thin client application 230b running on the thin client terminal 230. FIG. 5 illustrates respective processing blocks, i.e., a communication unit 231, an operation information acquiring unit 232, an update information acquiring unit 233, a screen update information decoder 234, a frame buffer 235, a screen display unit 236 and a rendering method switchover unit 237.

The communication unit 231 is an interface with the network N1. The communication unit 231 transmits and receives the data to and from the network N1 via the communication unit 104.

The operation information acquiring unit 232 acquires the information indicating the operation manipulated on the thin client application 230b by the user. The operation information acquiring unit 232 acquires a coordinate value of a position in which a mouse button is clicked. The operation information acquiring unit 232 acquires characters inputted from a keyboard.

The update information acquiring unit 233 receives update information transmitted by the update information notifying unit 227 of the thin client server 220. The screen update information decoder 234 decodes the update information received from the update information notifying unit 227 into image data in a non-compression format from the compression format, and notifies the frame buffer of the decoded image data. The frame buffer 235 retains the notified non-compression image data. The frame buffer 235 is built on, e.g., the main storage unit 102 of the thin client terminal 230.

The screen display unit 236 acquires the image from the frame buffer 235. The screen display unit 236 outputs the acquired image to an output unit instanced by the display.

The rendering method switchover unit 237 receives the command from the request information processing unit 22A of the thin client server 220. The rendering method switchover unit 237 extracts the URL contained in the web page display command when the received command is the web page display command. The rendering method switchover unit 237 instructs the web browser 230a to display the web page specified by the extracted URL. The rendering method switchover unit 237 is one example of an “instructing”.

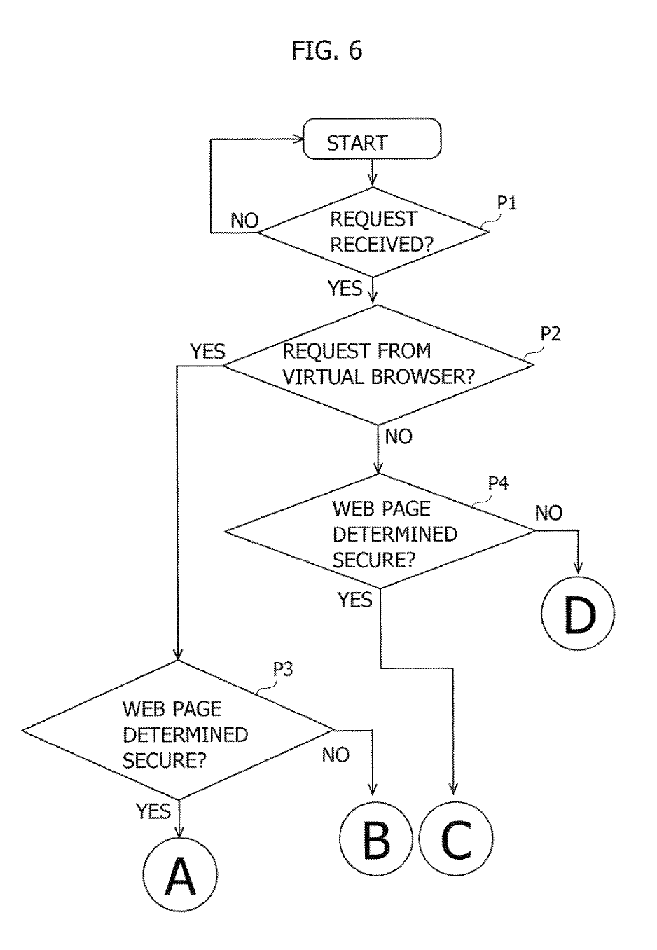

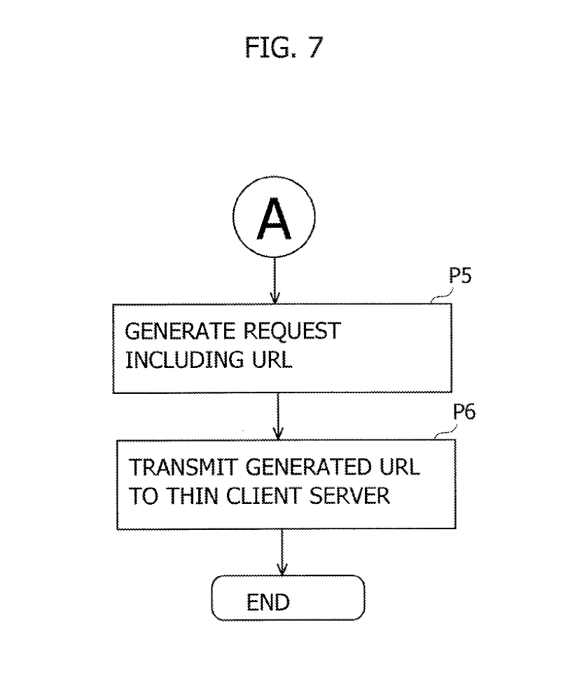

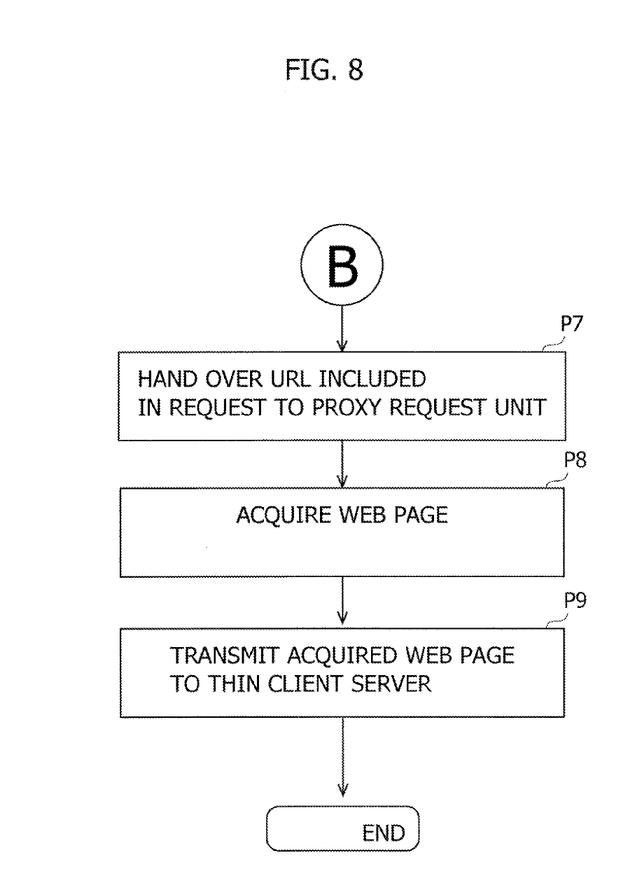

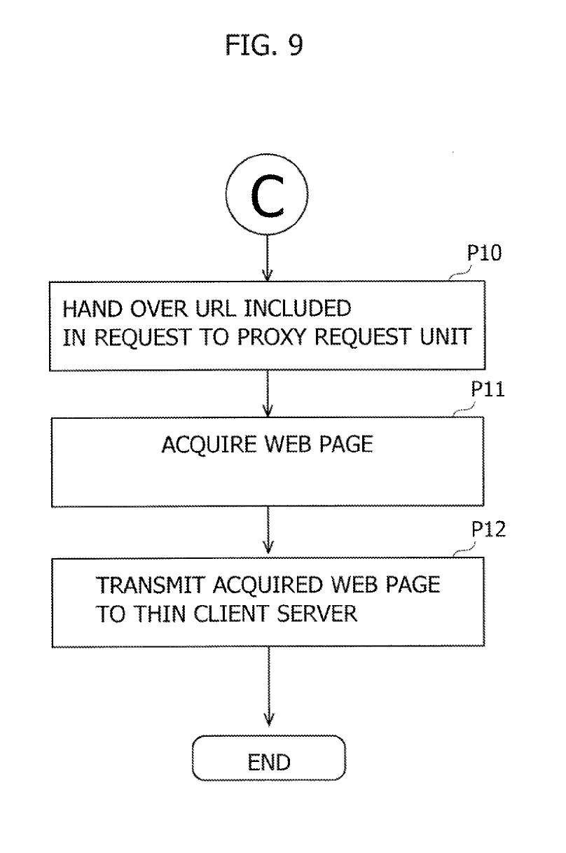

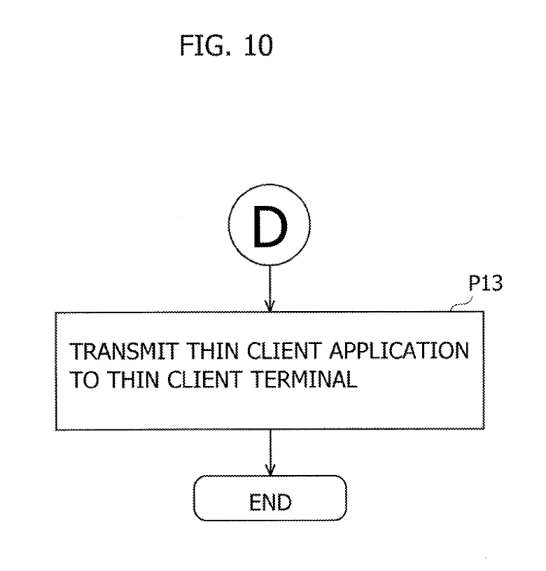

FIGS. 6 through 10 each illustrate one example of a processing flow of the proxy server 210. FIG. 6 is a first flowchart illustrating one example of the processing flow of the proxy server 210. FIG. 6 illustrates processes by the request reception unit 213 and the request determination unit 214 in FIG. 3. A symbol “A” in FIG. 6 is continued to “A” in FIG. 7. A symbol “B” in FIG. 6 is continued to “B” in FIG. 8. A symbol “C” in FIG. 6 is continued to “C” in FIG. 9. A symbol “D” in FIG. 6 is continued to “D” in FIG. 10. One example of the processes by the request reception unit 213 and the request determination unit 214 will hereinafter be described with reference to FIG. 6.

In P1, the request reception unit 213 receives the request from thin client server 220 or the thin client terminal 230 via the first communication unit 211. The request is a request for, e.g., accessing the web page. The process in P1 is one example of a process of “receiving identifying information of a browsing target web page”.

In P2, the request determination unit 214 determines whether the request received by the request reception unit 213 is a request given from the virtual browser 220a. The request determination unit 214 checks, e.g., a header field of a packet of the received request. The request determination unit 214 acquires, e.g., a source IP address written in the header field. The request determination unit 214 may determine that the received request is the request given from the virtual browser 220a when the acquired IP address is coincident with an IP address of the thin client server 220. The virtual browser 220a may set, e.g., the request to contain information indicating the request being given from the virtual browser 220a. The request contains the information indicating the request being given from the virtual browser 220a, and the request determination unit 214 is thereby enabled to determine whether the request is the request given from the virtual browser 220a. When given from the virtual browser 220a (YES in P2), the processing diverts to P3. Whereas when not given from the virtual browser 220a (NO in P2), the processing advances to P4.

In P3, the request determination unit 214 determines whether the requested web page is the secure web page. The request determination unit 214, when the URL contained in the request is not contained in the URL list 214a, determines that the requested web page is not the secure web page. When determining that the web page is the secure web page (YES in P3), the processing continues to “A”. Whereas when determining that the web page is not the secure web page (NO in P3), the processing continues to “B”.

In P4, the request determination unit 214 determines by the same process in P3 whether the requested web page is the secure web page. When determining that the web page is the secure web page (YES in P4), the processing continues to “C”. Whereas when determining that the web page is not the secure web page (NO in P4), the processing continues to “D”. The processes in P3 and P4 are one example of a process of “determining whether the browsing target web page satisfies the predetermined condition, based on identifying information stored in a storage unit and the received identifying information by referring to the storage unit to store the identifying information of the web page conforming to the predetermined condition”.

FIG. 7 is a second flowchart illustrating one example of the processing flow of the proxy server 210. FIG. 7 illustrates processes by the request information generation unit 215. The processes by the request information generation unit 215 will hereinafter be described with reference to FIG. 7.

In P5, the request information generation unit 215 generates request information containing the URL of the web page determined to be the secure web page by the request determination unit 214. In P6, the request information generation unit 215 transmits the generated request information to the thin client server 220.

FIG. 8 is a third flowchart illustrating one example of a processing flow of the proxy server 210. FIG. 8 illustrates processes by the request determination unit 214 and the proxy request unit 217. The processes by the request determination unit 214 and the proxy request unit 217 will hereinafter be described with reference to FIG. 8.

In P7, the request determination unit 214 extracts the URL contained in the received request. The request determination unit 214 hands over the extracted URL to the proxy request unit 217. In P8, the proxy request unit 217 acquires the web page identified by the URL handed over in P7. The process in P8 is one example of a process of “acquiring the web page identified by the received identifying information”.

In P9, the proxy request unit 217 transmits the acquired web page to the virtual browser 220a within the thin client server 220.

FIG. 9 is a fourth flowchart illustrating one example of the processing flow of the proxy server 210. FIG. 9 illustrates processes by the proxy request unit 217. The processes by the proxy request unit 217 will hereinafter be described with reference to FIG. 9.

Processes in P10 and P11 are the same as the processes in P7 and P8. Hence, the repetitive explanations thereof are omitted. In P12, the proxy request unit 217 transmits the acquired web page to the thin client terminal 230. The process in P11 is one example of a process of “acquiring the web page identified by the received identifying information”.

FIG. 10 is a fifth flowchart illustrating one example of a processing flow of the proxy server 210. FIG. 10 illustrates processes by the thin client application notification unit 216. The processes by the thin client application notification unit 216 will hereinafter be described with reference to FIG. 10.

In P13, the thin client application notification unit 216 transmits the thin client application 230b to the thin client terminal 230.

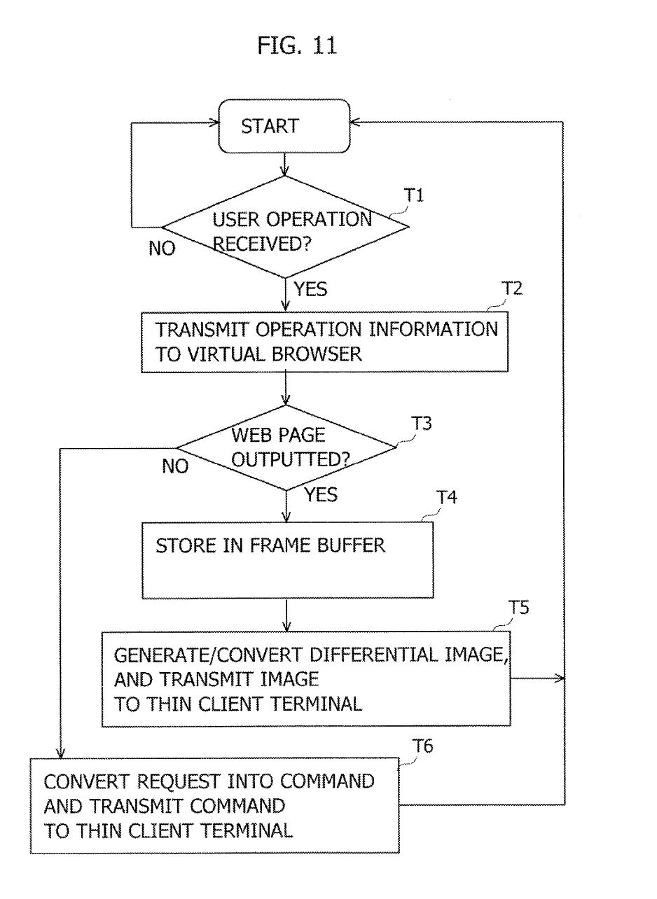

FIG. 11 is a flowchart illustrating one example of a processing flow of the thin client server 220. One example of the processing flow of the thin client server 220 will hereinafter be described with reference to FIG. 11.

In T1, the operation information acquiring unit 228 determines whether the operation information of the user is received from the thin client terminal 230. When received (YES in T1), the processing advances to T2. Whereas when not received (NO in T1), the process in T1 is iterated.

In T2, the operation information acquiring unit 228 transmits the operation information received via the OS running unit 221 to the virtual browser running unit 222. The virtual browser running unit 222 notifies the virtual browser 220a of the received operation information. the virtual browser 220a executes processing according to the inputted operation information. For example, when the mouse is clicked on a link containing the URL, a request for accessing to the web page specified by the URL is transmitted to the proxy server 210.

In T3, the virtual browser running unit 222 determines whether the virtual browser 220a outputs the web page. The virtual browser 220a outputs, as described above, the web page determined not to be the secure web page. In other words, when the virtual browser 220a does not output any web page, this is a case that the requested web page is determined to be the secure web page. When the virtual browser 220a outputs the web page (YES in T3), the processing advances to T4. Whereas when the virtual browser 220a does not output the web page (NO in T3), the processing diverts to T6.

In T4, the virtual browser 220a converts a screen of the outputted web page into an image. The converted image is stored in the frame buffer 224. In T5, the update rectangle forming unit 225 extracts an updated rectangular area, based on the images stored in the frame buffer saving unit 223 and the frame buffer 224. After the extraction, the update rectangle forming unit 225 saves, in the frame buffer saving unit 223, the image saved so far in the frame buffer 224. The update rectangle converting unit 226 compresses the rectangular area extracted by the update rectangle forming unit 225 in a predetermined image compression format. The update information notifying unit 227 transmits the compressed image of the rectangular area to the thin client terminal 230.

In T6, the request information processing unit 22A generates the web page display command containing the URL specifying the web page to be accessed. The web page display command is, as described above, the command for commanding the thin client application 230b to execute a process of handing over the URL contained in the web page display command to the web browser 230a. The request information processing unit 22A transmits the generated web page display command to the thin client terminal 230.

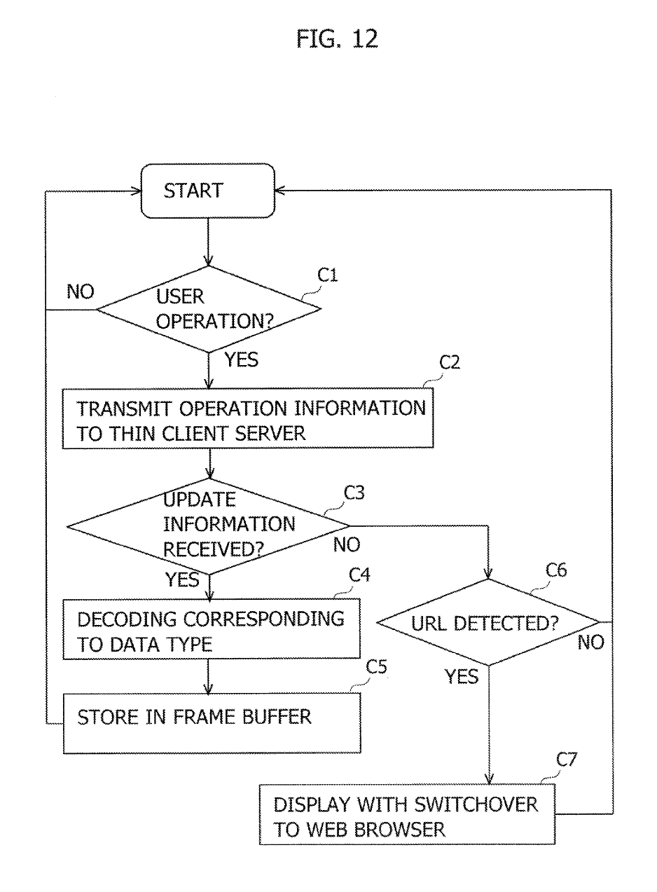

FIG. 12 is a flowchart illustrating one example of processes of the thin client terminal 230. The processes illustrated in FIG. 12 are executed by the thin client terminal 230 receiving the thin client application 230b in the process of, e.g., P14 in FIG. 10. One example of the processes of the thin client terminal 230 will hereinafter be described with reference to FIG. 12.

In C1, the operation information acquiring unit 232 determines whether the user manipulates the image displayed in the thin client application 230b. When the user's operation is conducted (YES in C1), the processing advances to C2. Whereas when the user's operation is not conducted (NO in C1), the process in C1 is iterated.

In C2, the operation information acquiring unit 232 transmits the operation information to the thin client server 220. The operation information contains the coordinate data indicating a position in which the mouse is clicked on the thin client application 230b.

In C3, the update information acquiring unit 233 determines whether update information is received from the thin client server 220. When the update information is received (YES in C3), the processing advances to C4. Whereas when the update information is not received (NO in C3), the processing diverts to C6.

In C4, the screen update information decoder 234 executes a decoding process suited to the image compression format of the update information received by the update information acquiring unit 233. The screen update information decoder 234 generates an image of the screen to be displayed on the output unit instanced by the display, based on the update information already undergoing the decoding process.

In C5, the screen update information decoder 234 stores the image generated in C4 in the frame buffer 235. The thin client application 230b displays the image stored in the frame buffer 235. The process in C5 is one example of a process of “converting the acquired web page into an image when the browsing target web page is determined not to satisfy the predetermined condition; and displaying the converted image to the display”.

In C6, the rendering method switchover unit 237 receives a command from the thin client server 220. The rendering method switchover unit 237 determines whether the received command contains the URL. In other words, it is determined in C6 whether the received command is the web page display command. When the command contains the URL (YES in C6), the processing advances to C7. Whereas when not containing the URL (NO in C6), the processing loops back to C1.

In C7, the rendering method switchover unit 237 extracts the URL from the received web page display command. The rendering method switchover unit 237 hands over the extracted URL to the web browser 230a. The rendering method switchover unit 237 instructs the web browser 230a to run, e.g., a reload command of JavaScript, thereby displaying the web page specified by the handed-over URL. By running the reload command, the web browser 230a transmits a request for acquiring the web page identified by the URL to the proxy server 210. The proxy server 210 transmits, to the thin client terminal 230, the web page identified by the received URL in the process illustrated in FIG. 9. The web browser 230a of the thin client terminal 230 displays the web page received from the proxy server 210. The reload command is one example of a command for commanding the web browser 230a to display the web page specified by the URL. With the web page being displayed on the web browser 230a, the thin client application 230b running on the web browser 230a is finished. The process in C7 is one example of a process of “displaying the acquired web page to a display when the browsing target web page is determined to satisfy the predetermined condition, the display being capable of displaying an image and a web page”.

An in-depth description of the processes in the thin client system 200 described above will be made by exemplifying respective scenarios given below.

A first scenario: the thin client terminal 230 accesses the web page determined to be the secure web page.

A second scenario: the thin client terminal 230 accesses the web page determined not to be the secure web page.

A third scenario: the thin client terminal 230 accesses the web page determined to be the secure web page subsequent to the process of the second scenario.

(First Scenario)

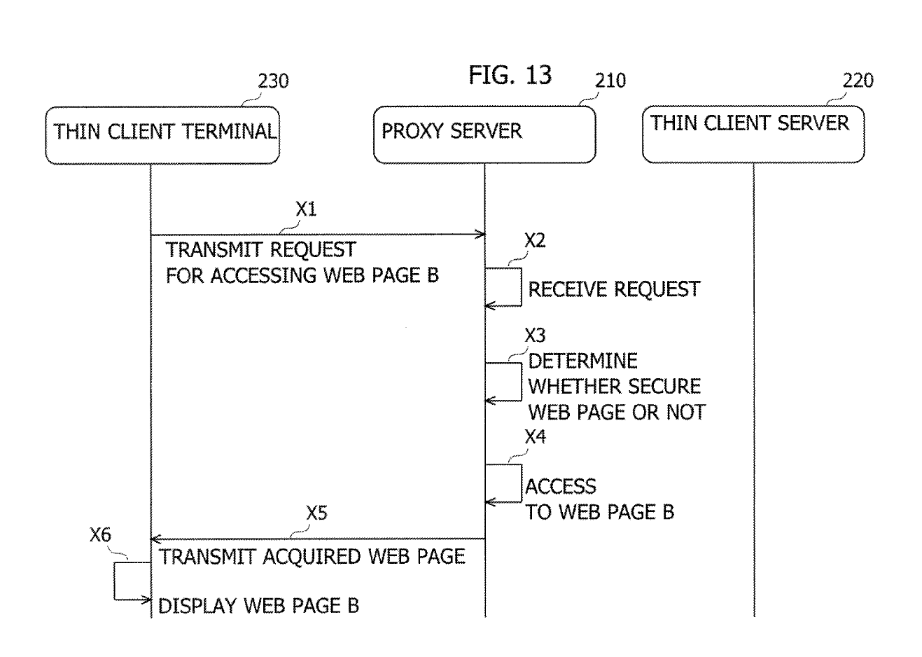

In the first scenario, as described above, the thin client terminal 230 accesses the web page determined to be the secure web page. In the present specification, the web page determined to be the secure web page will hereinafter be termed a web page B. The web page B is, e.g., a web page to be opened on the network N1. FIG. 13 is a diagram illustrating a process of the first scenario by the thin client system 200 according to the embodiment. One example of the process of the first scenario by the thin client system 200 according to the embodiment will hereinafter be described with reference to FIG. 13.

In X1, the web browser 230a of the thin client terminal 230 transmits the request containing the URL of the web page B to the proxy server 210. In X2, the request reception unit 213 of the proxy server 210 receives the request from the thin client terminal 230. In X3, the request determination unit 214 of the proxy server 210 determines whether the web page B is the secure web page, based on the URL contained in the received request. In the case of the first scenario, the web page B is determined to be the secure web page. In X4, the proxy request unit 217 of the proxy server 210 acquires the web page B. In X5, the proxy request unit 217 of the proxy server 210 transmits the acquired web page B to the thin client terminal 230. In X6, the web browser 230a of the thin client terminal 230 displays the web page B received from the proxy server 210.

(Second Scenario)

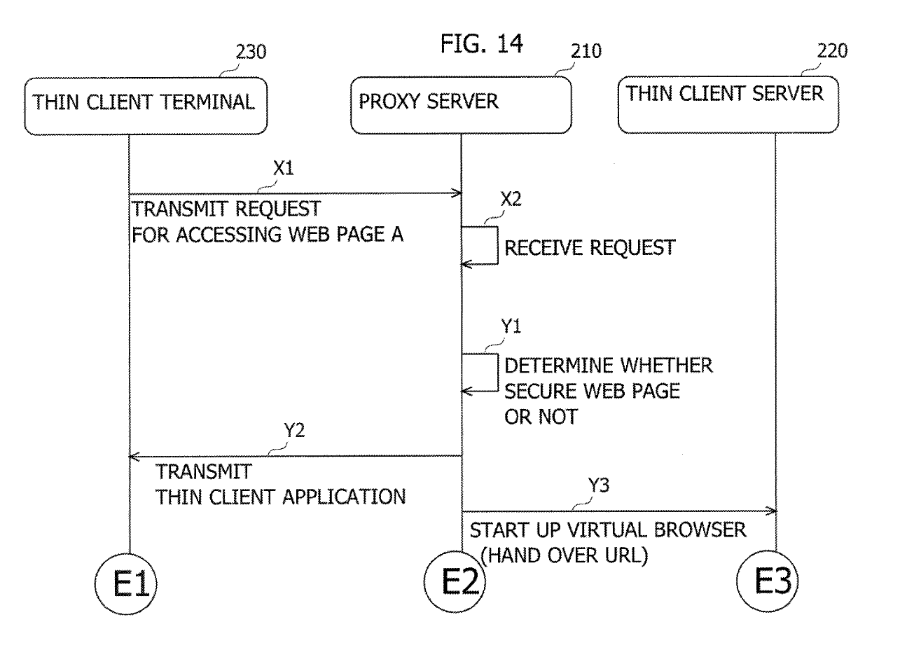

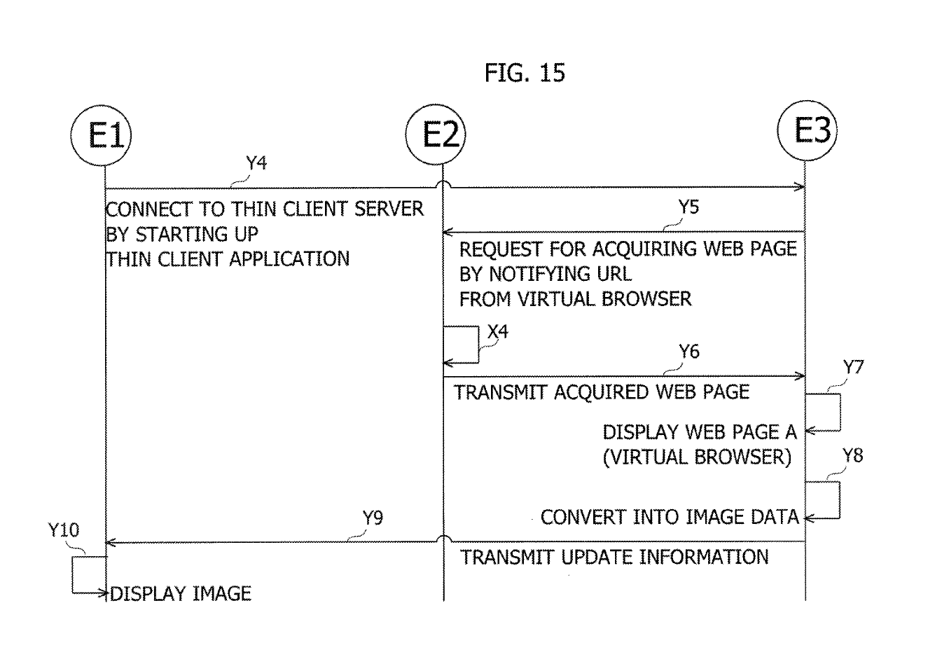

In the second scenario, as described above, the thin client terminal 230 accesses the web page determined not to be the secure web page. In the present specification, the web page determined not to be the secure web page will hereinafter be termed a web page A. The web page A is, e.g., a web page to be opened on the network N2. FIGS. 14 and 15 are diagrams each illustrating one example of a process of the second scenario by the thin client system 200 according to the embodiment. A symbol “E1” in FIG. 14 continues to “E1” in FIG. 15. A symbol “E2” in FIG. 14 continues to “E2” in FIG. 15. A symbol “E3” in FIG. 14 continues to “E3” in FIG. 15. The same processes as those of the first scenario are marked with the same numerals and symbols, and their repetitive explanations are omitted. One example of the process of the second scenario by the thin client system 200 according to the embodiment will hereinafter be described with reference to FIGS. 14 and 15.

Processes in X1, X2 of FIG. 14 and a process in X4 of FIG. 15 are the same as those in FIG. 13 except a point that the target web page becomes the web page A. Their repetitive explanations are therefore omitted. In Y1, the request determination unit 214 of the proxy server 210 determines whether the web page A is the secure web page, based on the URL contained in the received request. In the case of the second scenario, the web page A is determined not to be the secure web page. In Y2, the thin client application notification unit 216 of the proxy server 210 transmits the thin client application 230b to the thin client terminal 230. In Y3, the proxy server 210 transmits an instruction to start up the virtual browser 220a to the thin client server 220. The virtual browser running unit 222 of the thin client server 220 starts up the virtual browser 220a in accordance with the received instruction. The proxy server 210 hands over the URL contained in the received request to the virtual browser 220a.

In Y4 of FIG. 15, the thin client terminal 230 starts up the thin client application 230b on the web browser 230a. The thin client application 230b connects to the thin client server 220. In Y5, the virtual browser 220a notifies the URL of the web page A to the proxy server 210, thus making a request for acquiring the web page A. In Y6, the proxy request unit 217 of the proxy server 210 transmits the web page A acquired in the process of X4 to the thin client server 220. In Y7, the virtual browser 220a outputs the received web page A. In Y8, the virtual browser 220a converts the outputted screen into the image. The virtual browser 220a saves the converted image in the frame buffer 224. The update rectangle forming unit 225 and the update rectangle converting unit 226 extract the updated rectangular area in the image saved in the frame buffer 224. In Y9, the update information notifying unit 227 transmits the update information containing the extracted rectangular area to the thin client terminal 230. In Y10, the update information acquiring unit 233 of the thin client terminal 230 receives the transmitted update information. The screen display unit 236 displays the image converted from the screen of the web page A on the basis of the image saved in the frame buffer 235 and the received update information.

(Third Scenario)

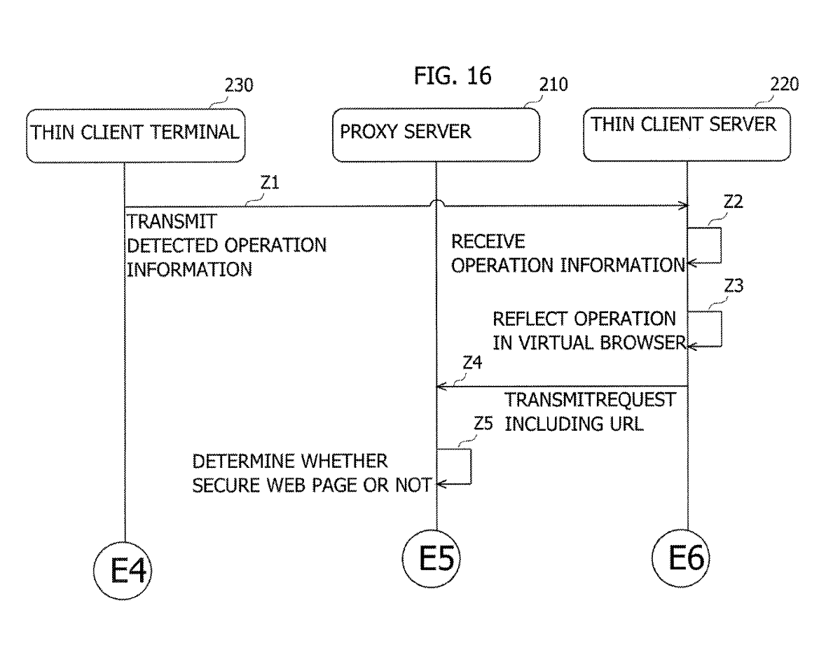

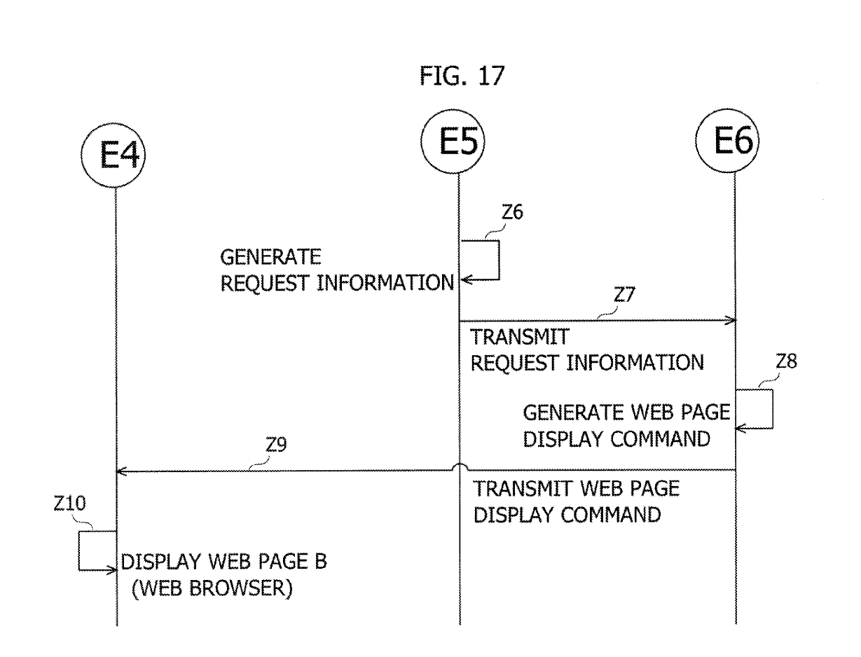

In the third scenario, as described above, subsequent to the process of the second scenario, the thin client terminal 230 accesses the web page determined to be the secure web page. FIGS. 16 and 17 are diagrams each illustrating the process of the third scenario by the thin client system 200 according to the embodiment. A symbol “E4” in FIG. 16 continues to “E4” in FIG. 17. A symbol “E5” in FIG. 16 continues to “E5” in FIG. 17. A symbol “E6” in FIG. 16 continues to “E6” in FIG. 17. One example of the process of the third scenario by the thin client system 200 according to the embodiment will hereinafter be described with reference to FIGS. 16 and 17.

In Z1 of FIG. 16, the thin client application 230b of the thin client terminal 230 detects the click operation of the mouse button, which is performed on the image of the displayed web page A. The thin client application 230b acquires the coordinate data indicating a position in which the click operation is performed. The thin client application 230b transmits the operation information containing the acquired coordinate data to the thin client server 220. In Z2, the operation information acquiring unit 228 of the thin client system 200 acquires the operation information transmitted from the thin client terminal 230. The operation information acquiring unit 228 transmits the acquired operation information to the virtual browser running unit 222. In Z3, the virtual browser running unit 222 extracts the coordinate data from the received operation information. The virtual browser running unit 222 reflects the operation information in the virtual browser 220a. It is herein assumed that a link containing the URL specifying the web page B exists in a target of the click operation. In Z4, the virtual browser 220a transmits the request containing the URL of the web page B to the proxy server 210. In Z5, the request determination unit 214 of the proxy server 210 determines whether the web page B is the secure web page, based on the URL contained in the received request. In the case of the third scenario, the web page B is determined to be the secure web page.

In Z6 of FIG. 17, the request information generation unit 215 generates request information containing the URL of the web page B. In Z7, the request information generation unit 215 transmits the generated request information to the thin client server 220. In Z8, the request information processing unit 22A of the thin client server 220 generates, based on the received request information, the web page display command containing the URL of the web page B. In Z9, the request information processing unit 22A transmits the generated web page display command to the thin client terminal 230. In Z10, the thin client application 230b of the thin client terminal 230 instructs the web browser 230a to display the web page B in accordance with the received web page display command.

### Comparative Example

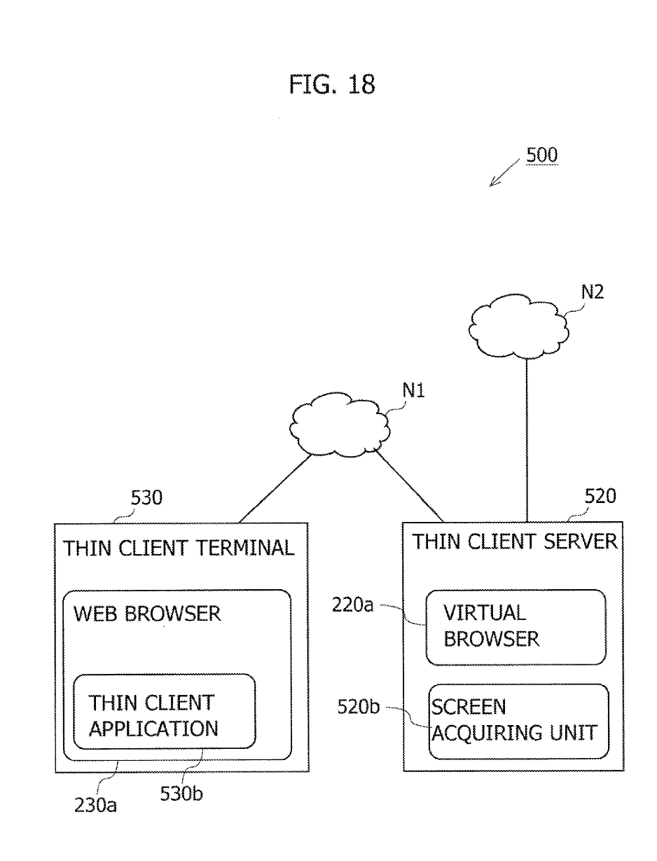

A comparative example to be compared with the embodiment will be described. FIG. 18 is a diagram illustrating one example of a thin client system 500 according to the comparative example. A thin client system 500 includes a thin client server 520 and a thin client terminal 530. The thin client server 520 and the thin client terminal 530 are the information processing apparatuses. The thin client server 520 and the thin client terminal 530 are interconnected in the communicable manner via the network N1. In the comparative example, the thin client server 520 receives a request for accessing the web page from the thin client terminal 530. The thin client server 520 receiving the request converts a screen of the web page A into an image. The thin client server 520 transmits the converted image to the thin client terminal 530. The thin client terminal 530 displays the received image. The comparative example will hereinafter be described with reference to the drawings.

Unlike the thin client system 200 according to the embodiment, the thin client system 500 according to the comparative example does not include the proxy server 210. The thin client server 520 therefore accesses the network N2 without via the proxy server 210.

The thin client terminal 530 is a terminal used by the user. The web browser 230a runs on the thin client terminal 530. A thin client application 530b runs on the web browser 230a. The thin client application 530b is different from the thin client application 230b according to the embodiment in terms of being incapable of executing the web page display command.

The thin client application 530b detects an operation of pressing the mouse button on the displayed image. The thin client application 530b acquires the coordinate data of a position in which the mouse button is pressed. The thin client application 530b transmits the acquired coordinate data to the thin client server 520. The virtual browser 220a in the thin client server 520, when the mouse is pressed as the operation information indicates and when the link containing the URL exists in the pressing target, displays the web page by accessing this web page. The virtual browser 220a converts the web page into the image. The thin client server 520 transmits the converted image to the thin client terminal 530. The thin client application 530b receives the web page converted into the image.

In the comparative example, the thin client application 530b is capable of displaying the received image. In the comparative example, however, all the web pages to be displayed are transmitted as the images to the thin client terminal 530. The thin client application 530b is thereby disabled from acquiring the URLs for identifying the web pages. As a result, the thin client application 530b is disabled from making the web browser 230a display the web page.

In the embodiment, the thin client application 230b extracts the URL contained in the web page display command when receiving the web page display command from the thin client server 220. The thin client application 230b instructs the web browser 230a to display the web page specified by the extracted URL. According to the embodiment, the thin client application 230b is thereby enabled to instruct the web browser 230a to display the web page.

According to the embodiment, the web page determined to be the secure web page is not converted into the image, and the URL of the web page is transmitted to the thin client terminal 230. The thin client system 200 according to the embodiment is therefore enabled to reduce a data traffic quantity between the thin client server 220 and the thin client terminal 230 to a greater degree than in the comparative example of transmitting all the web pages to be displayed as the images.

In the embodiment, the web page determined to be the secure web page by the proxy server 210 is displayed by the web browser 230a of the thin client terminal 230. The web page determined not to be the secure web page by the proxy server 210 is displayed as the image on the thin client application 230b of the thin client terminal 230. Hence, according to the embodiment, a decline of security of the thin client terminal 230 is restrained, and a decrease in convenience of the web page determined to be secure is restrained.

According to the embodiment, the update rectangle forming unit 225 extracts the updated rectangular area in the image saved in the frame buffer 224 by using the thin client server 220. The thin client server 220 transmits the image of the extracted rectangular area to the thin client terminal 230. Therefore, as compared with the case of transmitting the image saved in the frame buffer 224 in an as-is state, the embodiment enables a reduction in quantity of the data transmitted and received between the thin client server 220 and the thin client terminal 230. In the embodiment, the thin client server 220 compresses the image of the rectangular area formed by the update rectangle forming unit 225 by using the update rectangle converting unit 226. Hence, as compared with the case of transmitting the uncompressed image of the rectangular area, the embodiment enables a further reduction in quantity of the data transmitted and received between the thin client server 220 and the thin client terminal 230.

In the embodiment, the URL list 214a retains the URL of the secure web page. The request determination unit 214 determines by referring to the URL list 214a whether the web page specified by the URL contained in the request is the secure web page. In other words, according to the embodiment, it is determined whether the web page is the secure web page, based on the URL list 214a containing the URLs listed in a white list format. The URL list 214a is not, however, limited to the white list format. The URL list 214a may retain the URL of the web page determined not to be the secure web page. In other words, the URL list 214a may be structured to contain the URLs listed in a black list format. The URL list 214a containing the URLs listed in the white list format or the black list format is one example of a “memory configured to store identifying information of a web page conforming to a predetermined condition”. The URL list 214a containing the URLs listed in the white list format is one example of a “memory stores the identifying information of the web page excluded from a target of conversion into the image”. The URL list 214a containing the URLs listed in the black list format is one example of a “memory stores the identifying information of the web page becoming the target of conversion into the image”.

When the white list format is adopted for the URL list 214a, the web page identified by the URL not registered in the URL list 214a is converted into the image. When the black list format is adopted for the URL list 214a, the web page identified by the URL registered in the URL list 214a is converted into the image. When the white list format is adopted for the URL list 214a, it follows that the web pages other than the web pages confirmed to be high in security beforehand are converted into the images. It is therefore considered that the adoption of the white list format for the URL list 214a has the higher security than adopting the black list format. When the black list format is adopted for the URL list 214a, it follows that the web pages other than the web pages confirmed to be low in security beforehand can be browsed by the web browser 230a. It is therefore considered that the adoption of the black list format for the URL list 214a has the higher convenience than adopting the white list format.

The URL registered in the URL list 214a may be written by using a regular expression. For example, the web page, of which part is coincident with the URL registered in the URL list 214a, can be determined to be the secure web page by being written in the regular expression. In other words, the adoption of the regular expression enables the URL registered in the URL list 214a to be written more flexibly.

In the embodiment, the proxy server 210 and the thin client server 220 are prepared respectively as individual servers. A technology of the disclosure is not, however, limited to this configuration. According to the technology of the disclosure, e.g., the proxy server 210 and the thin client server 220 may be prepared as the same servers.

In the embodiment, the web page specified by the URL contained in the web page display command is displayed by reloading the web browser 230a. However, a method of causing the web browser 230a to display the web page specified by the URL contained in the web page display command is not limited to this method. The web page specified by the URL contained in the web page display command may be displayed in a newly opened window by the web browser 230a. The web page specified by the URL contained in the web page display command may also be displayed in a newly opened tab by the web browser 230a.

The present information processing apparatus can restrain the decline of convenience of the web page while assuring the security of the terminal.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory configured to store identifying information of a web page conforming to a predetermined condition; and
a processor coupled to the memory and the processor configured to perform:
receiving identifying information from a server to provide a terminal with an image converted from a web page or the identifying information of the web page;
determining whether the web page identified by the identifying information satisfies the predetermined condition, based on the identifying information stored in the memory and the received identifying information;
first transmitting the received identifying information to the server when the determining determines that the web page identified by the identifying information satisfies the predetermined condition;
acquiring the web page identified by the identifying information when the determining determines that the web page identified by the identifying information does not satisfy the predetermined condition; and
second transmitting the acquired web page to the server.

2. The information processing apparatus according to claim 1, wherein the memory stores the identifying information of the web page excluded from a target of conversion into the image, and
the determining determines that the web page identified by the identifying information satisfies the predetermined condition when the received identifying information is stored in the memory.

3. The information processing apparatus according to claim 1, wherein the memory stores the identifying information of the web page becoming the target of conversion into the image, and
the determining determines that the web page identified by the identifying information satisfies the predetermined condition when the received identifying information is not stored in the memory.

4. An information processing apparatus comprising:
a memory; and
a processor coupled to the memory and the processor configured to perform:
receiving a web page or identifying information of the web page;
converting, upon receiving the web page, the received web page into an image;
first transmitting the converted image to a destination terminal; and
second transmitting the received identifying information to the destination terminal upon receiving the identifying information.

5. An information processing method, comprising:
receiving identifying information of a web page becoming a browsing target;
acquiring the web page identified by the received identifying information;
determining whether the browsing target web page satisfies a predetermined condition, based on identifying information stored in a memory and the received identifying information by referring to the memory to store the identifying information of the web page conforming to the predetermined condition;
displaying the acquired web page to a display when the browsing target web page is determined to satisfy the predetermined condition, the display being capable of displaying an image and a web page;
converting the acquired web page into an image when the browsing target web page is determined not to satisfy the predetermined condition; and
displaying the converted image to the display.
